(19) United States
(12) Patent Application Publication
(10) Pub. No.: US 2025/0065907 A1
(43) Pub. Date: Feb. 27, 2025

(54) PERCEIVING AND ASSOCIATING STATIC AND DYNAMIC OBJECTS USING GRAPH MACHINE LEARNING MODELS

(71) Applicant: QUALCOMM Incorporated, San Diego, CA (US)

(72) Inventors: Venkatraman NARAYANAN, Farmington Hills, MI (US); Varun RAVI KUMAR, San Diego, CA (US); Senthil Kumar YOGAMANI, Headford, Galway (IE)

(21) Appl. No.: 18/456,218

(22) Filed: Aug. 25, 2023

(51) Int. Cl. B60W 60/00; G06N 3/08

(52) U.S. Cl. CPC B60W 60/001; G06N 3/08; B60W 2554/80

(57) ABSTRACT

Certain aspects of the present disclosure provide techniques and apparatus for improved machine learning. A set of object detections, each respective object detection in the set of object detections corresponding to a respective object detected in an environment, is accessed. Based on the set of object detections, a graph representation comprising a plurality of nodes is generated, where each respective node in the plurality of nodes corresponds to a respective object detection in the set of object detections. A set of output features is generated based on processing the graph representation using a trained message passing network. A predicted object relationship graph is generated based on processing the set of output features using a layer of a trained machine learning model.

### INTRODUCTION

Aspects of the present disclosure relate to machine learning.

A wide variety of machine learning model architectures have proliferated and have been used to provide solutions for a multitude of prediction problems. For example, in computer vision tasks, machine learning models have been trained to identify and classify objects, to estimate depth to depicted objects, and the like. Such computer vision tasks may be prevalent in various solutions such as autonomous or assisted navigation (e.g., self-driving vehicles, such as cars, trucks, aircraft, and the like).

The relationships between objects or concepts in the real world can be highly complex. However, understanding these relationships can enable substantially improved outcomes. For example, in an autonomous driving scenario, understanding the causal relationships between objects (e.g., pedestrians and vehicles, vehicles and obstacles, and the like) may be useful to improve the safety and effectiveness of the autonomous navigation. However, acquiring or learning these relationships is often intractable using conventional approaches. Some conventional approaches involve use of hand-crafted rules or heuristics designed based on domain expertise, or attempts to learn abstract relationships using reward-based learning systems. These conventional approaches are rigid, inflexible, non-scalable, and often inaccurate.

### BRIEF SUMMARY

Certain aspects provide a method, comprising: accessing a set of object detections, each respective object detection in the set of object detections corresponding to a respective object detected in an environment; generating, based on the set of object detections, a graph representation comprising a plurality of nodes, wherein each respective node in the plurality of nodes corresponds to a respective object detection in the set of object detections; generating a set of output features based on processing the graph representation using a trained message passing network; and generating a predicted object relationship graph based on processing the set of output features using a layer of a trained machine learning model.

Certain aspects provide a method, comprising: accessing a set of object detections, each respective object detection in the set of object detections corresponding to a respective object detected in an environment; generating, based on the set of object detections, a first graph representation corresponding to a first moment in time, wherein each respective node in the first graph representation corresponds to a respective object detection in the set of object detections; generating a set of output features based on processing the first graph representation using a message passing network; generating a predicted object relationship graph based on processing the set of output features using a layer of a machine learning model; generating, based on the set of object detections, a second graph representation corresponding to a second moment in time subsequent to the first moment in time; and updating one or more parameters of the message passing network and the layer of the machine learning model based on the predicted object relationship graph and the second graph representation.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 illustrates an example workflow for predicting object relationships and generating corresponding actions, according to various aspects of the present disclosure.

FIG. 2 depicts an example architecture for predicting object relationships using graph machine learning models, according to various aspects of the present disclosure.

FIG. 3 is a flow diagram depicting an example method for training graph machine learning models to predict object relationships, according to various aspects of the present disclosure.

FIG. 4 is a flow diagram depicting an example method for predicting object relationships using graph machine learning, according to various aspects of the present disclosure.

FIG. 5 is a flow diagram depicting an example method for generating graph representations of depicted scenes to enable graph machine learning, according to various aspects of the present disclosure.

FIG. 6 is a flow diagram depicting an example method for using message passing models to evaluate and update graph representations of depicted scenes, according to various aspects of the present disclosure.

FIG. 7 is a flow diagram depicting an example method for training machine learning models, according to various aspects of the present disclosure.

FIG. 8 is a flow diagram depicting an example method for predicting object relationships using machine learning, according to various aspects of the present disclosure.

FIG. 9 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for graph machine learning to predict object relationships.

Object association refers to the process of acquiring knowledge about the relationships between different objects or concepts. Object association is a valuable ability in a variety of systems. For example, an autonomous vehicle may be able to operate more safely and effectively if the vehicle's computer systems are able to recognize and understand the objects in the environment, and learn or predict how those objects are related to each other or will affect or react to each other. This relationship prediction can enable the vehicle to respond more accurately and reasonably to the behavior of other objects in the environment, such as predicting the movement of other vehicles, pedestrians, and obstacles. For example, learning the relationships between cars and traffic lights (e.g., how cars will respond to various traffic light states), or between pedestrians and crosswalks (e.g., how pedestrians respond to crosswalks, or lack thereof), can enable autonomous or assisted driving systems to approach such objects more safely.

In some aspects, a wide variety of objects can be detected and evaluated, depending on the particular implementation. In some aspects, objects may generally be classified as either dynamic or static based on their characteristics or nature. For example in an autonomous or assisted navigation setting, dynamic objects may include objects that move relative to the scene or environment (e.g., the ego vehicle, other vehicles, pedestrians, bicyclists, animals, and the like). Similarly, static objects may include those that do not move relative to the scene or environment, though such objects may appear to move relative to the ego vehicle (e.g., traffic signs, traffic lights, round boundary markers, lane markers, debris, and the like).

In some aspects, graph machine learning models (e.g., graph neural networks (GNNs)) are used to learn relationships between objects in a scene. A graph may be constructed, where nodes in the graph represent objects in the scene and edges represent relationships between those objects. For example, the nodes may represent cars, pedestrians, and traffic signals present in the scene, and the edges may represent data such as the relative velocity, distances, and directions between those objects.

In some aspects, each node in the graph is associated with a feature vector that describes the properties of that object, such as the object's position, velocity, and other relevant characteristics. In some aspects, message passing in GNNs is leveraged to learn object associations. As used herein, message passing generally refers to learning or updating the state of a given node based on passing information to and/or from connected neighbor nodes in a graph. In some aspects, the model iteratively updates the features of each node in the graph based on the features of the neighboring nodes using message passing. This can allow the GNN to learn to recognize and model complex relationships between objects in the scene.

In some aspects, the resulting output comprises predicted relationships between objects (e.g., predicting the relationship at a future point in time, such as whether the relative velocities and distances between each pair of objects will increase, decrease, or stay the same). In some aspects, these predicted relationships can thereafter be used to drive a variety of solutions, such as selecting autonomous or assisted navigation actions (e.g., path planning, determining to accelerate or decelerate, and the like).

Although assisted or autonomous driving and navigation is used as an example problem space which may be improved using the presently disclosed techniques and architectures, aspects of the present disclosure are readily applicable to a wide variety of environments and problems. Generally, any problem space that involves determining or predicting object associations or relationships may benefit from the techniques and architectures disclosed herein.

### Example Workflow for Predicting Object Relationships and Generating Corresponding Actions

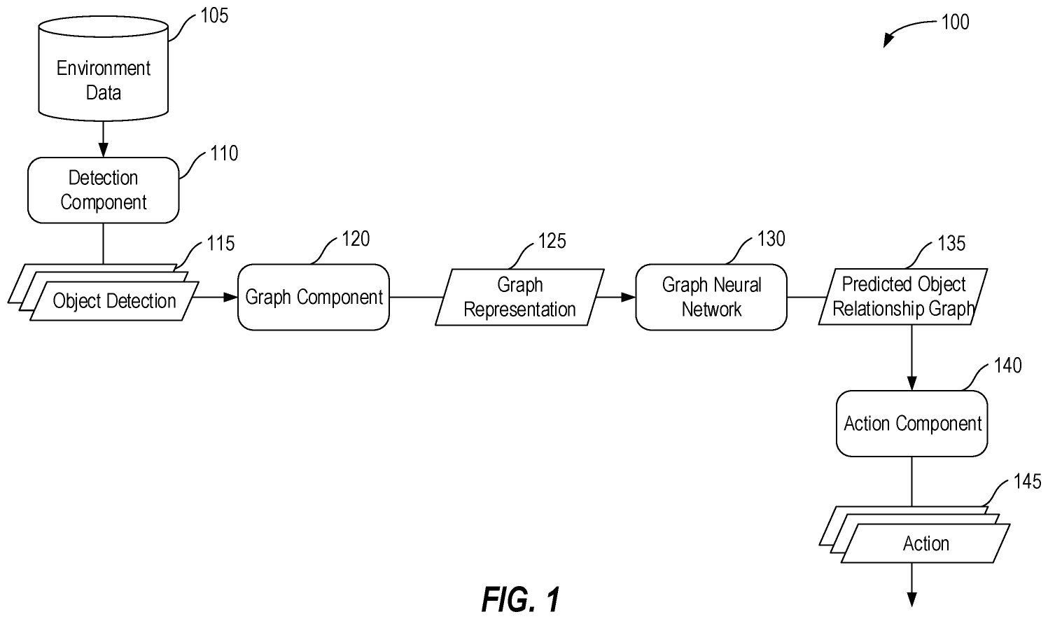

FIG. 1 illustrates an example workflow 100 for predicting object relationships and generating corresponding actions, according to various aspects of the present disclosure. The illustrated workflow 100 is performed by a variety of components, including a detection component 110, a graph component 120, a graph neural network 130, and an action component 140. Although depicted as discrete components for conceptual clarity, in other aspects, the operations of the depicted components (and others not pictured) may be combined or distributed across any number and variety of components and systems, and may be implemented using hardware, software, or a combination of hardware and software.

In the illustrated example, environment data 105 is accessed by the detection component 110. As used herein, “accessing” data generally includes receiving, requesting, retrieving, collecting, generating, measuring, or otherwise gaining access to the data. The environment data 105 generally comprises sensor data from a real (physical) or virtual environment, such as light detection and ranging (LIDAR) data, camera data (e.g., images and/or video), radar data, and the like. The detection component 110 generally uses a variety of techniques and operations to generate a set of object detections 115 based on the environment data 105. For example, depending on the particular content and format of the environment data 105 (as well as the desired content and format of the object detections 115), the detection component 110 may use a variety of operations such as processing the environment data 105 using one or more machine learning models (e.g., neural network backbones), combining the features extracted from each domain or type of the environment data 105, processing these combined features using a decoder neural network, and the like.

The object detections 115 generally indicate the object(s) that were detected in the environment data 105. That is, each of the object detections 115 may correspond to a physical object in the environment (e.g., a vehicle, a stop sign, and the like). The particular contents and format of the object detections 115 may vary depending on the particular implementation. For example, in some aspects, the object detections 115 comprise bounding boxes (or other bounding polygons or other shapes) in multidimensional space (e.g., in two-dimensional space, if the bounding boxes are indicated relative to the position of the ego vehicle, or in three-dimensional space).

In the illustrated workflow 100, the object detections 115 are accessed by the graph component 120, which evaluates the object detections 115 to generate a graph representation 125 of the objects in the scene. In some aspects, the graph component 120 generates a respective node for each respective object detection 115. In some aspects the graph component 120 further generates a respective feature vector for each respective node, where the feature vector generally indicates or describes the properties or characteristics of the corresponding object. For example, the feature vector may indicate the class or type of the corresponding object and/or object detection 115 (e.g., whether the object is dynamic or static and/or a specific semantic class, such as whether the object is a truck, car, pedestrian, tree, and the like).

In some aspects, the graph component 120 may generate a respective feature vector for each respective object detection 115 indicating information such as (without limitation) the position of the corresponding object (e.g., using global coordinates, or relative to the ego vehicle), the size of the corresponding object (e.g., the absolute size relative to the world, or the apparent size relative to the ego vehicle), and/or the orientation or heading of the corresponding object (e.g., relative to the scene or environment, or relative to the ego vehicle). In some aspects, the feature vectors may indicate, for example, but without limitation, the physical or apparent texture of the corresponding object, the vulnerability of the corresponding object (e.g., using a vulnerability measure indicating a defined mapping, such as indicating that pedestrians are highly vulnerable, bicyclists are slightly less vulnerable than pedestrians, cars are less vulnerable than bicyclists, and trucks are less vulnerable than cars), the visibility of the corresponding object (e.g., the percentage of the object that is occluded from the perspective of the ego vehicle), and the like.

In some aspects, the feature vectors may include information such as the velocity of the corresponding object (relative to the scene or environment and/or relative to the ego vehicle) and/or the acceleration of the corresponding object (relative to the scene or environment and/or relative to the ego vehicle). In some aspects, the velocity and acceleration information may be included if the object is a dynamic object (and omitted if the object is static). In some aspects, the feature vector may include information such as the contents of the corresponding object. For example, if the object is a traffic sign, the contents may refer to the text on the sign (e.g., the speed limit, the street name, and the like). As another example, the feature vector may include the status of the corresponding object. For example, if the object is a traffic light, the status may indicate which light (e.g., green, yellow, or red) is illuminated. As another example, if the object is a vehicle, the status may indicate which turn signal is on (if any), whether the hazard lights are on, whether the headlights and/or taillights are on, whether the brake lights are illuminated, and the like. In some aspects, the contents and status information may be included if the object is a static object (and omitted if the object is dynamic).

Generally, the particular properties evaluated and/or included in the feature vector for a given node (corresponding to a given object detection 115) may vary depending on the particular implementation, and may generally include any feature suitable for or relevant to predicting the relationships between objects in the environment.

In some aspects, to generate the graph representation 125, the graph component 120 may additionally generate one or more edges connecting pairs (or groups) of nodes in the graph. In some aspects, the graph component 120 generates an edge between each pair of nodes (e.g., such that the graph representation 125 is fully connected, where each node has an edge to each other node). In some aspects, one or more of the generated edges may be directional (e.g., indicating directionality of the relationship, such as where a first object affects a second, but the second object does not affect the first object) or bidirectional (where the relationship is bidirectional). For example, based on a defined mapping, the graph component 120 may determine to insert a directional edge from a static object to a dynamic one (e.g., from a stop sign node to a vehicle node), indicating that the dynamic object may react to or change its state or properties in response to the static object, but that the static object will not change in response to the dynamic object. In some aspects, such a relationship may be bidirectional (e.g., where a vehicle may stop in response to a traffic light turning red, and the traffic light may turn to green in response to detecting the vehicle). In other aspects, the graph component 120 may use bidirectional edges for all the connections, allowing the model itself to learn the directionality of the relationships.

In some aspects, the graph component 120 may generate a respective feature vector for each respective edge in the graph, based on the current (e.g., visible or perceivable) relationship between the corresponding objects. For example, for edges between nodes corresponding to two dynamic objects, the graph component 120 may generate a feature vector indicating the relative distance, velocity, and/or acceleration between the corresponding objects.

As another example, for edges connecting nodes corresponding to two static objects, the graph component 120 may generate a feature vector indicating the relative position and/or angle between the objects, the semantic similarity of the objects (e.g., whether the objects belong to the same broader class or category, such as cars and trucks both belonging to a vehicle class), and/or the geometric similarity between the objects (e.g., whether the objects have the same or similar geometry, or otherwise are visibly similar).

As another example, for edges connecting a node corresponding to a dynamic object and a node corresponding to a static object, the graph component 120 may generate a feature vector indicating the relative position between the objects, the relevance of each object on the other (e.g., using a defined mapping or score indicating whether each object will react or change based on the other, or the magnitude of such reaction), and the like.

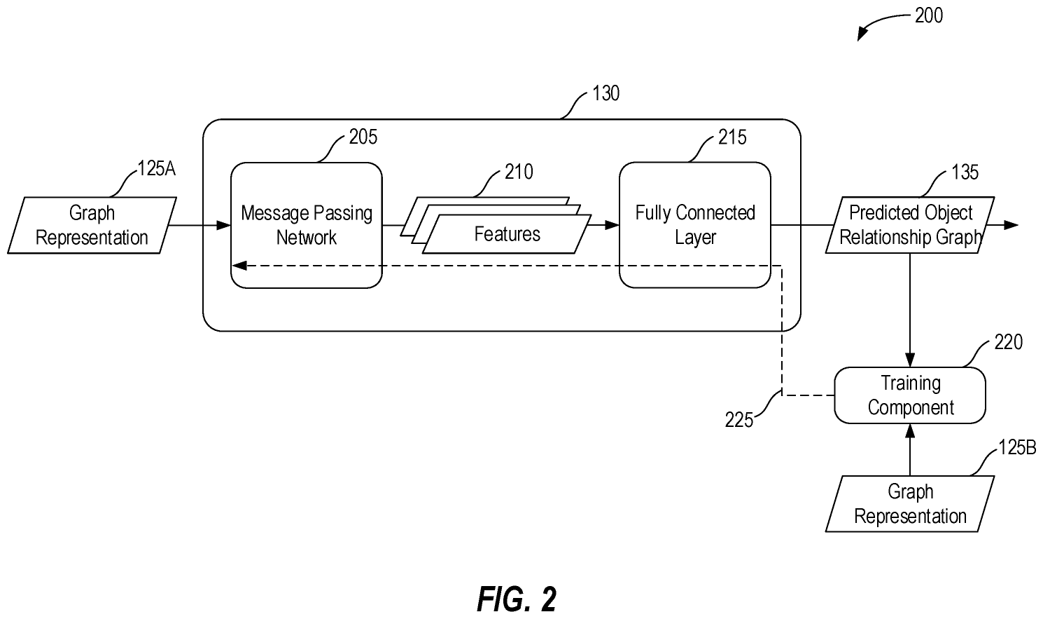

In the illustrated example, once the graph representation 125 has been generated to reflect the current (perceived) state of the environment, the graph neural network 130 can be used to propagate information through the graph (e.g., using message passing) to generate a predicted object relationship graph 135. One example approach for generating the predicted object relationship graph 135 using the graph neural network 130 is discussed in more detail below with reference to FIG. 2.

In some aspects, the predicted object relationship graph 135 indicates the predicted relationships between objects at some future point (or window) in time. For example, if the graph representation 125 indicates relative velocities between two objects at the current time (e.g., when the environment data 105 was collected), the predicted object relationship graph 135 may indicate the predicted relative velocities between the objects in the future (e.g., in five seconds, during the next window of five seconds, and the like). Generally, the predicted object relationship graph 135 may indicate a wide variety of relationships or associations between objects, depending on the particular implementation. For example, in some aspects, the predicted object relationship graph 135 may indicate the same or similar features as those discussed above with reference to feature vectors generated for each edge in the graph representation 125 (e.g., relative distances, relative velocities, relative acceleration, relative positions, relative angles, semantic and/or geometric similarity, and/or relevance).

In some aspects, the predicted object relationship graph 135 is used as output from the workflow 100, and may be consumed by any number and variety of downstream components and systems for evaluation. For example, in the illustrated example, the predicted object relationship graph 135 is accessed by the action component 140, which evaluates the predicted object relationship graph 135 to generate a set of one or more actions 145.

Generally, the operations of the action component 140 (and the contents of the actions 145) may vary depending on the particular implementation. For example, in an autonomous driving environment, the predicted object relationship graph 135 may be evaluated to provide better scene understanding. By modeling the relationships between different objects and their properties, the system may improve the accuracy of object detection and tracking algorithms, as well as other components of the autonomous driving system. As another example, the predicted object relationship graph 135 may be used to enable or improve object tracking. That is, the predicted object relationship graph 135 may be used to efficiently track the movement of multiple objects in a scene over time based at least in part on the relationships between such objects. As another example, the predicted object relationship graph 135 may be used to enable or improve path planning (e.g., generating a planned movement path). For example, modeling the relationships between objects in a scene may help to identify potential hazards and avoid collisions with other objects. This helps in determining the optimal (or at least improved) route for the autonomous vehicle to take in a given situation. For example, the predicted object relationship graph 135 may be leveraged to plan a movement path for a vehicle to take through a crowded intersection, taking into consideration the relationships between the present objects. As another example, predicting the behavior of other vehicles on the road may allow the system to adjust the ego vehicle's speed and/or trajectory accordingly.

In this way, the actions 145 may include a wide variety of operations, such as instructing an autonomous vehicle to accelerate, decelerate, maintain velocity, turn or steer towards one side or the other, navigate along a defined route, and the like. Generally, the particular operations used to actually implement or perform these actions 145 may vary depending on the particular implementation.

### Example Architecture for Predicting Object Relationships Using Graph Machine Learning Models

FIG. 2 depicts an example architecture 200 for predicting object relationships using graph machine learning models, according to various aspects of the present disclosure. In some aspects, the architecture 200 provides additional detail for the training and runtime use of the graph neural network 130 of FIG. 1. The illustrated architecture 200 includes a variety of components, including the graph neural network 130 and a training component 220. Although depicted as discrete components for conceptual clarity, in other aspects, the operations of the depicted components (and others not pictured) may be combined or distributed across any number and variety of components and systems, and may be implemented using hardware, software, or a combination of hardware and software.

As discussed above, a graph-based representation of the objects detected in an environment (e.g., a graph representation 125 of FIG. 1) may be accessed as input to the graph neural network 130, which generates a predicted object relationship graph 135 indicating the (predicted) relationships or associations between two or more of the detected objects at a future point or window in time. In the illustrated example, a graph representation 125A (corresponding to a first point in time) is used as input to the graph neural network 130, while a second graph representation 125B (corresponding to a second point in time, subsequent to the first point in time) is used to train the model during training. During inferencing, this training process may be omitted.

As illustrated, the graph neural network 130 comprises a message passing network 205 and a fully connected layer 215. The message passing network 205 generally corresponds to a machine learning model (e.g., a neural network) that uses message passing to update the node and/or edge features of the graph representation 125A in order to generate a set of features 210. The features 210 are then processed by the fully connected layer 215 to generate the output predicted object relationship graph 135, as discussed in more detail below.

In some aspects, the message passing network 205 propagates information through the graph representation 125A using a message-passing algorithm where, at each iteration, each respective node sends a message to the connected neighboring node(s) based on the feature vector of the respective node and the feature vector of the connecting edge to each neighbor. The messages are then aggregated at each node to produce a new feature vector for the node, where this new feature vector incorporates the information from neighboring nodes (conditioned based on the edge features). In some aspects, the message passing function is implemented using a multi-layer perceptron (MLP).

In some aspects, the message passing functionality of the message passing network 205 is defined using Equation 1 below:

$${m}_{ij} = M L P ( c o n c a t ( {h}_{i}^{k} , {h}_{j}^{k} , {e}_{i j} ) ) \qquad ( 1 )$$

where mᵢⱼ is the message or feature vector passed to node i from node j. MLP( ) corresponds to processing data using a MLP, hᵢ^{k} is the representation of node i in the k-th layer of the message passing network 205 (e.g., the feature vector of the node at the k-th layer, which may be the initial feature vector generated by the graph component if the k-th layer is the first layer), hⱼ^{k} is the feature vector of the node j in the k-th layer, and eᵢⱼ is the feature vector of the edge connecting nodes i and j, which encodes the (current) relationship between the corresponding objects. In Equation 1, the concatenation operation concat( ) is used to combine the feature vectors of both nodes and the edge feature vector (e.g., by concatenating or stacking these vectors). In some aspects, other aggregation operations such as summing or averaging may be used to combine the vectors.

In some aspects, Equation 1 may be used to generate message vectors for each pair of nodes (e.g., for each edge) at one or more layers of the message passing network 205. Generally, the MLP function in Equation 1 uses a set of trained weights or other parameters (e.g., with values learned during training) to generate the message vector based on the input features. In aspects, there may generally be any number of layers (also referred to as iterations) in the message passing network 205. In some aspects, the weights used by the MLP operation may be shared across layers, or the message passing network 205 may use layer-specific weights.

In the illustrated architecture, after computing the message vectors for all edges (e.g., using Equation 1) in a given layer, the node features at each respective node are updated based on the respective received messages using a graph convolutional layer. In some aspects, to generate the updated representation (e.g., updated feature vector) of each respective node, the message passing network 205 may sum the message vector(s) from the corresponding neighboring nodes, multiply the sum based on a learned weight (or weights), and apply an activation function.

For example, in some aspects, the graph convolutional layer used to update the node representations may be defined using Equation 2 below:

$${h}_{i}^{k + 1} = R e L U ( {\sum }_{j ∈ N ( i )} ( {m}_{i j} * {W}^{k} ) ) \qquad ( 1 )$$

where hᵢ^{k+1} is the updated representation of the node i (e.g., the feature vector of node i) at the (k+1)-th layer, ReLU( ) indicates application of the ReLU activation function (though other activation functions may similarly be used), mᵢⱼ is the message vector corresponding to the edge connecting nodes i and j and generated within the current layer (e.g., layer k), and W^{k} is a learnable weight matrix for layer k.

In some aspects, by repeatedly applying the message passing and graph convolutional layers (e.g., across K iterations or layers of the message passing network 205), the message passing network 205 can learn relationships between dynamic objects, between static objects, and between dynamic and static objects in the environment (e.g., in autonomous driving scenes).

In the illustrated example, the resulting output from the message passing network 205 is a set of features 210. For example, the features 210 may correspond to the updated node representations output by the final layer of the message passing network 205. In some aspects, the features 210 may additionally include the edge feature vectors. Further, though a set of features 210 is depicted for conceptual clarity, in some aspects, the output of the message passing network 205 may be an updated graph representation (e.g., a graph having edges and associated edge vectors, as well as nodes and the updated node feature vectors).

As illustrated, the features 210 are evaluated by a fully connected layer 215 to generate the predicted object relationship graph 135. That is, once the information has been propagated across the graph, the final vectors (e.g., features 210) associated with each node can be used to predict object relationships. In some aspects, the fully connected layer 215 is used to predict the relationship (if any) between each pair of connected nodes based on their respective features 210. The predicted object relationships (reflected in the predicted object relationship graph 135) can then be used to inform decision-making (e.g., in an autonomous driving system), as discussed above.

In some aspects, the fully connected layer 215 predicts how the objects will affect each other and/or what will happen in the scene in the future (e.g., where objects will move, how their relative positions and velocities will change, and the like). In some aspects, this fully connected layer 215 may evaluate the graph to retain only those connections or edges that actually affect each given node. For example, if a given node or edge does not affect the output features 210 of a connected node (or affects the output features 210 of the connected node below a defined threshold), the fully connected layer 215 may prune or remove this edge. In this way, the predicted object relationship graph 135 may contain fewer edges than the graph representation 125A (which may be fully connected), as the predicted object relationship graph 135 may only include edges between nodes that actually have an effect on each other (in one or both directions).

In some aspects, the fully connected layer 215 evaluates the updated vector representations (e.g., features 210) for each node to generate or update a corresponding edge feature vector (e.g., indicating the predicted future relationship between the nodes), such as to indicate the (predicted) relative velocities, distances, accelerations, and any other relevant attribute, as discussed above.

In the illustrated example, the predicted object relationship graph 135 may be output from the architecture 200 for use by other components (e.g., by the action component 140 of FIG. 1) during runtime. In the illustrated example, during training, the predicted object relationship graph 135 is accessed by a training component 220. The training component 220 also accesses a graph representation 125B. As discussed above, the graph representation 125B may generally correspond to a graph representation of the environment or scene for a second point or moment in time subsequent to the point or moment in time to which the graph representation 125A corresponds. For example, if the graph representation 125A corresponds to the state of the environment or scene (e.g., based on environment data 105 of FIG. 1) at time t, the graph representation 125B may indicate the state of the environment or scene at a future time t+1 (e.g., generated based on subsequent environment data).

In the illustrated example, the training component 220 formulates a loss to seek to cause the generated predicted relationships (e.g., predicted object relationship graph 135) to align with or match the actual relationships (reflected in the graph representation 125B) at the subsequent time. To that end, the training component 220 may use a variety of loss formulations to compare the predicted object relationship graph 135 and the graph representation 125B. As illustrated by the arrow 225, the loss may then be used to update the parameter(s) of the fully connected layer 215 and the message passing network 205 (e.g., using backpropagation). In this way, the graph neural network 130 iteratively learns to accurately predict relationships between objects based on the graph representations 125. Although the illustrated example suggests updating the graph neural network 130 based on a single pair of graph representations 125 (e.g., using stochastic gradient descent) for conceptual clarity, in some aspects, the training component 220 may additionally or alternatively use batches of graph representations 125 (e.g., using batch gradient descent) to train the graph neural network 130.

### Example Method for Training Graph Machine Learning Models to Predict Object Relationships

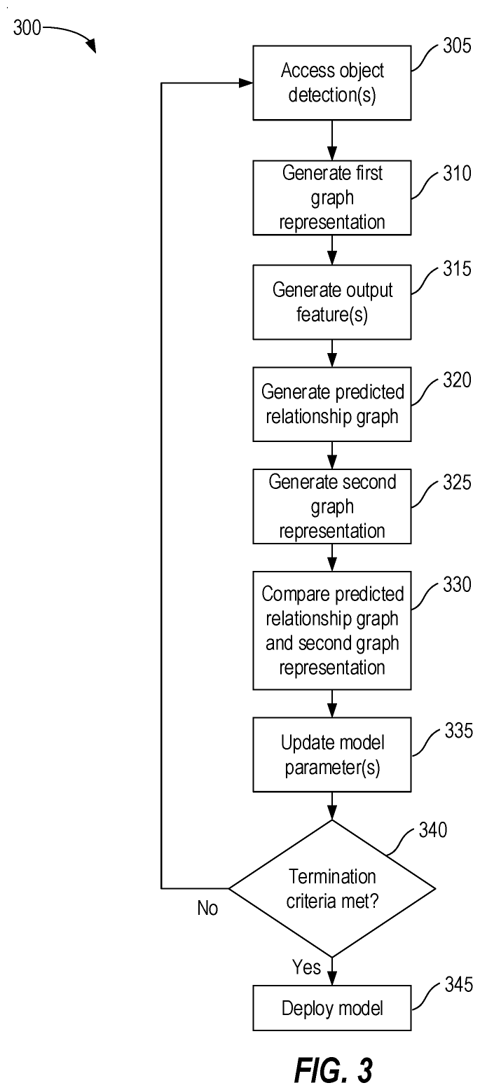

FIG. 3 is a flow diagram depicting an example method 300 for training graph machine learning models to predict object relationships, according to various aspects of the present disclosure. In some aspects, the method 300 is performed by a training system (e.g., a computing system that trains graph neural networks for deployment), such as the training component 220 of FIG. 2. In some aspects, the method 300 provides additional detail for the techniques and examples discussed above with reference to the workflow 100 of FIG. 1 and/or the architecture 200 of FIG. 2.

At block 305, the training system accesses a set of object detections (which may correspond to the object detections 115 of FIG. 1). As discussed above, the object detections generally indicate the presence of various objects in a scene or environment (e.g., in a physical environment around an autonomous vehicle). For example, the object detections may comprise, for each object in the scene, a bounding box (or other polygon) indicating the position, orientation and/or size of the object. In some aspects, some or all of the object detections may further indicate characteristics or attributes of the corresponding object, such as the class or category of the object (e.g., whether the object is a car, truck, or pedestrian). As discussed above, the object detections may be generated using a wide variety of detection algorithms and models to process input sensor data from the environment.

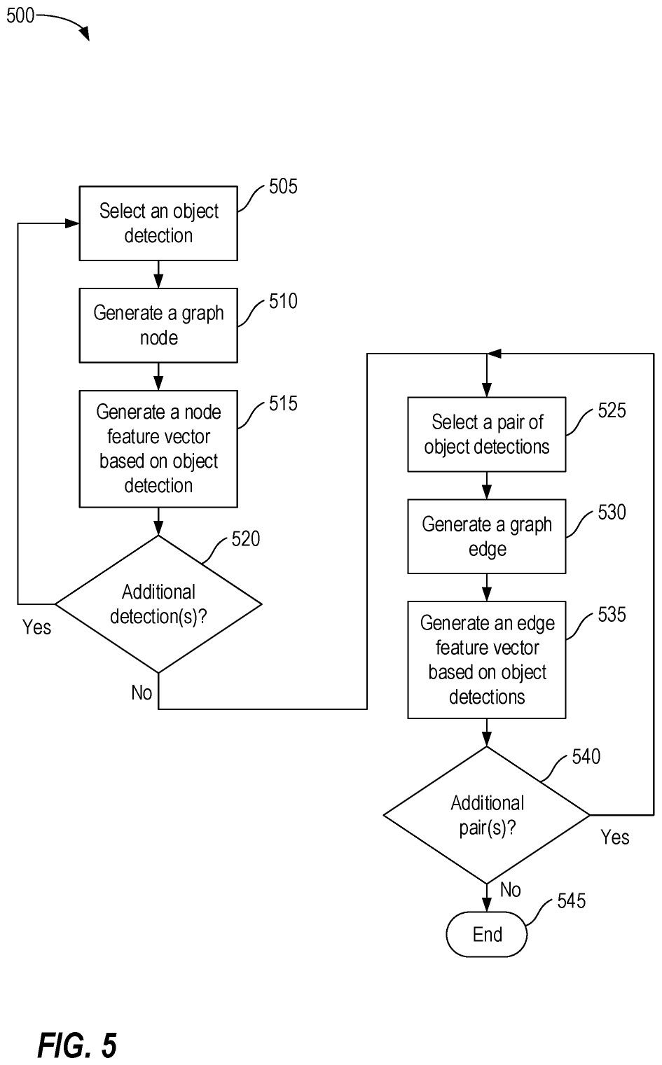

At block 310, the training system generates a first graph representation (e.g., the graph representation 125A in FIG. 2) based on at least a subset of the object detections. For example, as discussed above, the training system may evaluate the detections corresponding to a given moment or window in time (e.g., at time t), and generate a graph representation of these detections. In some aspects, as discussed above, the graph representation may have a set of nodes (one node for each object detection) as well as a set of edges (e.g., connecting all pairs of nodes). In some aspects, as discussed above and in more detail below with reference to FIG. 5, the training system may further generate feature vectors for each node and/or edge in the graph representation.

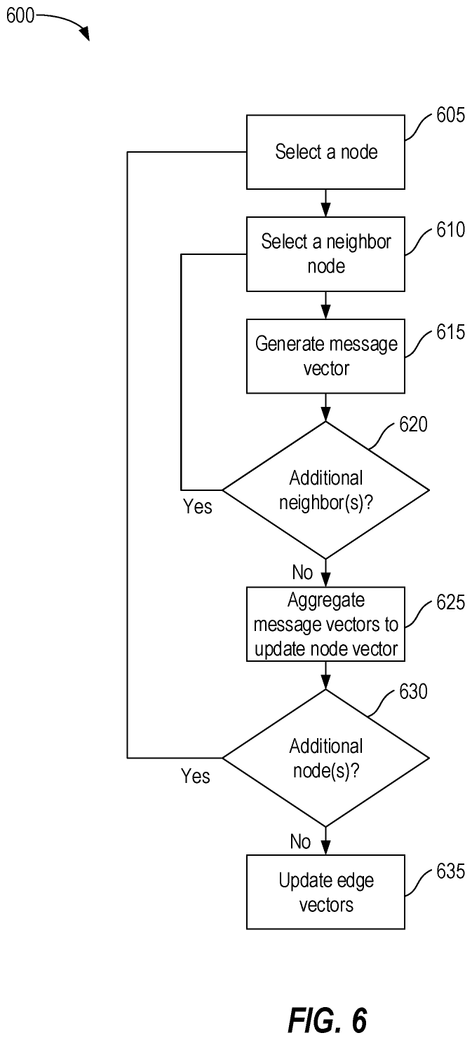

At block 315, the training system generates a set of output features (e.g., features 210 of FIG. 2) based on processing the graph representation using all or a portion of a graph neural network (such as the graph neural network 130 of FIG. 1). For example, as discussed above, the training system may process the graph representation using a message passing network (such as the message passing network 205 of FIG. 2) to generate updated feature vectors for each node in the graph representation. One example method for generating the output features is discussed below in more detail with reference to FIG. 6.

At block 320, the training system generates a predicted object relationship graph (e.g., the predicted object relationship graph 135 of FIG. 1) based on the set of features. For example, as discussed above, the training system may process the features using a layer of the graph neural network (e.g., a final and/or fully connected layer, such as the fully connected layer 215 of FIG. 2) to generate the predicted object relationship graph. In some aspects, as discussed above, the training system may prune one or more edge(s) from the graph, and/or update edge feature vectors in the graph, based on processing the output features (generated at block 315) with the fully connected layer.

At block 325, the training system generates a second graph representation (e.g., the graph representation 125B in FIG. 2) based on at least a subset of the object detections. For example, as discussed above, the training system may evaluate the detections corresponding to a subsequent moment or window in time, relative to the first time (e.g., at time t+1), and generate a graph representation of these detections. In some aspects, as discussed above, the graph representation may have a set of nodes (one node for each object detection) as well as a set of edges (e.g., connecting all pairs of nodes). In some aspects, as discussed above and in more detail below with reference to FIG. 5, the training system may further generate feature vectors for each node and/or edge in the second graph representation.

At block 330, the training system compares the predicted object relationship graph and the second graph representation. For example, as discussed above, the training system may seek to refine the model such that the predicted object relationship graph aligns with the actual second graph representation (e.g., the predicted future relationships are similar to or the same as the actual future relationships).

At block 335, the training system updates one or more parameter(s) of the graph neural network based on this comparison (e.g., by backpropagating a loss generated based on the comparison). Although the illustrated example depicts updating the graph neural network based on a single pair of graph representations (e.g., using stochastic gradient descent) for conceptual clarity, in some aspects, the training system may additionally or alternatively use batches of graph representations (e.g., using batch gradient descent) to train the graph neural network.

At block 340, the training system determines whether one or more termination criteria are met. Generally, the particular operations used to evaluate the termination criteria may vary depending on the particular implementation. For example, in some aspects, the training system may determine whether any additional training samples remain (e.g., additional object detections and/or environment data), whether additional iterations or epochs remain, whether a defined amount of time or resources have been spent training the model, whether a desired accuracy has been reached, and the like. If the termination criteria are not met, the method 300 returns to block 305. If the training system determines that the criteria are met, the method 300 proceeds to block 345.

At block 345, the training system deploys the trained graph neural network for inferencing. Generally, deploying the model may include any operations used to prepare or provide the trained model for inferencing. For example, the training system may compile the model, transmit the model to one or more other systems for inferencing, deploy the mode locally for inferencing, and the like.

### Example Method for Predicting Object Relationships Using Graph Machine Learning

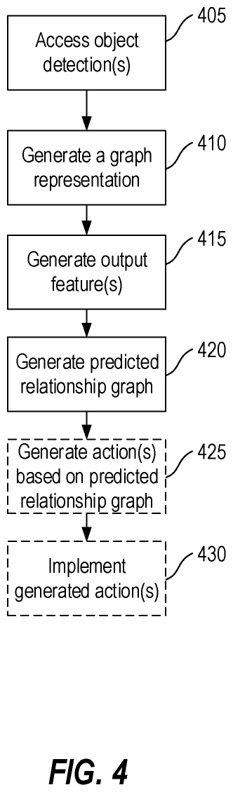

FIG. 4 is a flow diagram depicting an example method 400 for predicting object relationships using graph machine learning, according to various aspects of the present disclosure. In some aspects, the method 400 is performed by an inferencing system (e.g., a computing system that uses trained graph neural networks to generate predictions). In some aspects, the method 300 provides additional detail for the techniques and examples discussed above with reference to the workflow 100 of FIG. 1 and/or the architecture 200 of FIG. 2.

At block 405, the inferencing system accesses a set of object detections (which may correspond to the object detections 115 of FIG. 1). As discussed above, the object detections generally indicate the presence of various objects in a scene or environment (e.g., in a physical environment around an autonomous vehicle). For example, the object detections may comprise, for each object in the scene, a bounding box (or other polygon) indicating the position, orientation and/or size of the object. In some aspects, some or all of the object detections may further indicate characteristics or attributes of the corresponding object, such as the class or category of the object (e.g., whether the object is a car, truck, or pedestrian). As discussed above, the object detections may be generated using a wide variety of detection algorithms and models to process input sensor data from the environment.

At block 410, the inferencing system generates a graph representation (e.g., the graph representation 125 in FIG. 1) based on at least a subset of the object detections. For example, as discussed above, the inferencing system may evaluate the detections corresponding to a given moment or window in time (e.g., at time t), and generate a graph representation of these detections. In some aspects, as discussed above, the graph representation may have a set of nodes (one node for each object detection) as well as a set of edges (e.g., connecting all pairs of nodes). In some aspects, as discussed above and in more detail below with reference to FIG. 5, the inferencing system may further generate feature vectors for each node and/or edge in the graph representation.

At block 415, the inferencing system generates a set of output features (e.g., features 210 of FIG. 2) based on processing the graph representation using all or a portion of a graph neural network (such as the graph neural network 130 of FIG. 1). For example, as discussed above, the inferencing system may process the graph representation using a message passing network (such as the message passing network 205 of FIG. 2) to generate updated feature vectors for each node in the graph representation. One example method for generating the output features is discussed below in more detail with reference to FIG. 6.

At block 420, the inferencing system generates a predicted object relationship graph (e.g., the predicted object relationship graph 135 of FIG. 1) based on the set of features. For example, as discussed above, the inferencing system may process the features using a layer of the graph neural network (e.g., a final fully connected layer, such as the fully connected layer 215 of FIG. 2) to generate the predicted object relationship graph. In some aspects, as discussed above, the inferencing system may prune one or more edge(s) from the graph, and/or update edge feature vectors in the graph, based on processing the output features (generated at block 315) with the fully connected layer. In some aspects, as discussed above, the predicted object relationship graph generally indicates predicted relationships or associations between objects at a point in time subsequent to the point corresponding to the graph representation (e.g., at time t+1).

At block 425, the inferencing system optionally generates one or more actions (e.g., actions 145 of FIG. 1) based on the predicted object relationship graph. For example, the inferencing system may determine or select one or more movements in a physical environment that an autonomous vehicle should implement, based on the predicted relationships and associations between objects. For example, as discussed above, the inferencing system may generate a planned movement path for an autonomous vehicle (that takes into account the predicted relationships of the detected objects), movement instructions such as accelerate, decelerate, maintain velocity, turn or steer left or right, and the like. Generally, the inferencing system may use a wide variety of operations or models to generate the actions.

At block 430, the inferencing system optionally implements the generated action(s). As used herein, implementing an action may generally refer to actually performing an action (e.g., transmitting data), instructing or causing another system to implement the action (e.g., instructing an autonomous vehicle to perform the action), or otherwise facilitating the action (e.g., by indicating the action to another system that can implement the action). For example, as discussed above, the inferencing system may cause an autonomous vehicle to navigate along the selected path, to make the indicated movements, and the like. Generally, the inferencing system may use a wide variety of operations or models to implement the actions.

### Example Method for Generating Graph Representations of Depicted Scenes to Enable Graph Machine Learning

FIG. 5 is a flow diagram depicting an example method 500 for generating graph representations (e.g., graph representation 125 of FIG. 1) of depicted scenes to enable graph machine learning, according to various aspects of the present disclosure. In some aspects, the method 500 is performed by a computing system (e.g., a training system that trains graph neural networks, an inferencing system that uses trained graph neural networks, or a separate and independent system). In some aspects, the method 500 provides additional detail for block 310 of FIG. 3, block 325 of FIG. 3, and/or block 410 of FIG. 4.

At block 505, the computing system selects an object detection reflected in the set of object detections (e.g., the object detections 115 of FIG. 1). Generally, the computing system may use any suitable technique, including random or pseudo-random selection, to select the object detection, as all detections corresponding to a given time (e.g., time t) will be evaluated during performance of the method 500.

At block 510, the computing system generates a graph node to represent the selected object detection. At block 515, the computing system generates a node feature vector based on the object detection (e.g., based on attributes of the object to which the detection corresponds). Generally, as discussed above, the node feature vector may include a variety of information depending on the particular implementation. In some aspects, the node feature vector may include any information about the object detection (or about the object itself) that is relevant to predicting object associations. By way of example and not limitation, the node feature vector may encode information such as the position of the object, the size of the object, the orientation of the object, the texture of the object, the vulnerability measure, score, or class of the object, the visibility or occlusion of the object, the velocity of the object, the acceleration of the object, the contents of the object, and/or the status of the object.

At block 520, the computing system determines whether there is at least one additional object detection for the given time. If so, the method 500 returns to block 505. If not, the method 500 continues to block 525. Although the illustrated example depicts an iterative process (where the computing system selects and evaluates each object detection sequentially) for conceptual clarity, in some aspects, the computing system may evaluate some or all of the detections in parallel.

At block 525, the computing system selects a pair of object detections (or, equivalently, selects a pair of nodes in the graph). Generally, the computing system may use any suitable technique, including random or pseudo-random selection, to select the pair, as all pairs will be evaluated during performance of the method 500.

At block 530, the computing system generates a graph edge for the selected pair of object detections (e.g., connecting the corresponding pair of nodes in the graph). As discussed above, these edges may be directional (e.g., based on the effect each object has on the other, if any) or bidirectional (where each object may affect the other).

At block 535, the computing system generates an edge feature vector for the generated edge based on the selected object detections (e.g., based on the current relationship of the pair of objects to which the selected detections correspond). Generally, as discussed above, the edge feature vector may include a variety of information depending on the particular implementation. In some aspects, the edge feature vector may include any information about the pair of object detections (or about the objects themselves) that is relevant to predicting object associations. By way of example and not limitation, the edge feature vector may encode information such as the relative distance between the objects, the relative velocity between the objects, the relative acceleration between the objects, the relative position between objects, the relative angle between the objects, the semantic similarity of the objects, and/or the geometric similarity of the objects.

At block 540, the computing system determines whether there is at least one additional pair of object detections for the given time. If so, the method 500 returns to block 525. If not, the method 500 terminates at block 545. Although the illustrated example depicts an iterative process (where the computing system selects and evaluates each pair of detections sequentially) for conceptual clarity, in some aspects, the computing system may evaluate some or all of the pairs in parallel.

In this way, the computing system can efficiently generate a graph representation that fully captures the current state of the environment and all detected objects within the environment, allowing the computing system to evaluate the graph to predict future associations or relationships between the objects.

### Example Method for Using Message Passing Models to Evaluate and Update Graph Representations of Depicted Scenes

FIG. 6 is a flow diagram depicting an example method 600 for using message passing models (e.g., the message passing network 205 of FIG. 2) to evaluate and update graph representations of depicted scenes, according to various aspects of the present disclosure. In some aspects, the method 600 is performed by a computing system (e.g., a training system that trains graph neural networks, an inferencing system that uses trained graph neural networks, or a separate and independent system). In some aspects, the method 600 provides additional detail for blocks 315 and 320 of FIG. 3 and/or blocks 415 and 420 of FIG. 4.

At block 605, the computing system selects a node in the graph representation. Generally, the computing system may use any suitable technique, including random or pseudo-random selection, to select the node, as all nodes in the graph will be evaluated during performance of the method 600.

At block 610, the computing system selects a neighbor node. That is, the computing system selects one of the nodes that has an edge connecting this node to the node which was selected at block 605. As above, the computing system may use any suitable technique, including random or pseudo-random selection, to select the neighbor node, as all neighbors of the selected node will be evaluated during performance of the method 600.

At block 615, the computing system generates a message vector for the selected neighbor node with respect to the node selected at block 605. For example, as discussed above, the computing system may generate the message vector based on the (current) feature vector of the selected node (selected at block 605), the (current) feature vector of the selected neighbor node, and the feature vector of the edge connecting the selected pair of nodes. In some aspects, the computing system uses Equation 1, above, to generate the message vector.

At block 620, the computing system determines whether there is at least one additional neighbor node for the selected node. If so, the method 600 returns to block 610. If not, the method 600 continues to block 625. Although the illustrated example depicts an iterative process (where the computing system selects and evaluates each neighbor sequentially) for conceptual clarity, in some aspects, the computing system may evaluate some or all of the neighbors in parallel.

At block 625, after message vectors for a given node have been generated based on all neighbors, the computing system aggregates the message vectors to generate an updated node feature vector for the node which was selected at block 605. That is, the computing system generates an updated feature vector, which can be used as the output of the message passing network or as the current vector of the node during the subsequent iteration or layer. In some aspects, when processing other nodes during the current iteration or layer, the computing system uses the current feature vector of the node (e.g., the feature vector used to generate the message vectors) rather than the newly updated vector. Generally, the computing system may use a variety of operations to aggregate the messages. In some aspects, as discussed above, the computing system uses Equation 2 to aggregate the messages.

At block 630, the computing system determines whether there is at least one additional node (that does not yet have an updated feature vector) remaining in the graph. If so, the method 600 returns to block 605. If not, the method 600 continues to block 635. Although the illustrated example depicts an iterative process (where the computing system selects and evaluates each node sequentially) for conceptual clarity, in some aspects, the computing system may evaluate some or all of the nodes in parallel.

The illustrated example depicts a single iteration or layer of the message passing network for conceptual clarity (e.g., a single iteration of blocks 605 through 630 to generate a single updated feature vector for each node). However, in some aspects, the computing system may use multiple such iterations, as discussed above. For example, the computing system may perform blocks 605 through 630 to generate an updated node feature vector for each node at a given iteration, and then use these updated node feature vectors during a subsequent iteration to generate a new set of updated feature vectors for the nodes. This process may be repeated or iterated any number of times, depending on the particular implementation.

At block 635, the computing system updates the edge vector(s) of the graph based on the updated feature vectors for each node. For example, as discussed above, the computing system may process the updated node feature vectors using a final fully connected layer (e.g., fully connected layer 215 of FIG. 2) to update the edge feature vectors to reflect the predicted relationship(s) among objects. In some aspects, as discussed above, updating the edge vectors may include updating their values to indicate the predicted relationships (e.g., relative velocities), updating the edges themselves (e.g., by pruning edges) to reflect which relationships or associations actually exist in the environment (e.g., where removing an edge indicates that the corresponding objects are unrelated and/or will not affect each other), and the like.

In this way, the computing system can efficiently generate an accurate predicted object relationship graph (e.g., predicted object relationship graph 135 of FIG. 1) that can be used for a wide variety of purposes, as discussed above.

### Example Method for Training Machine Learning Models

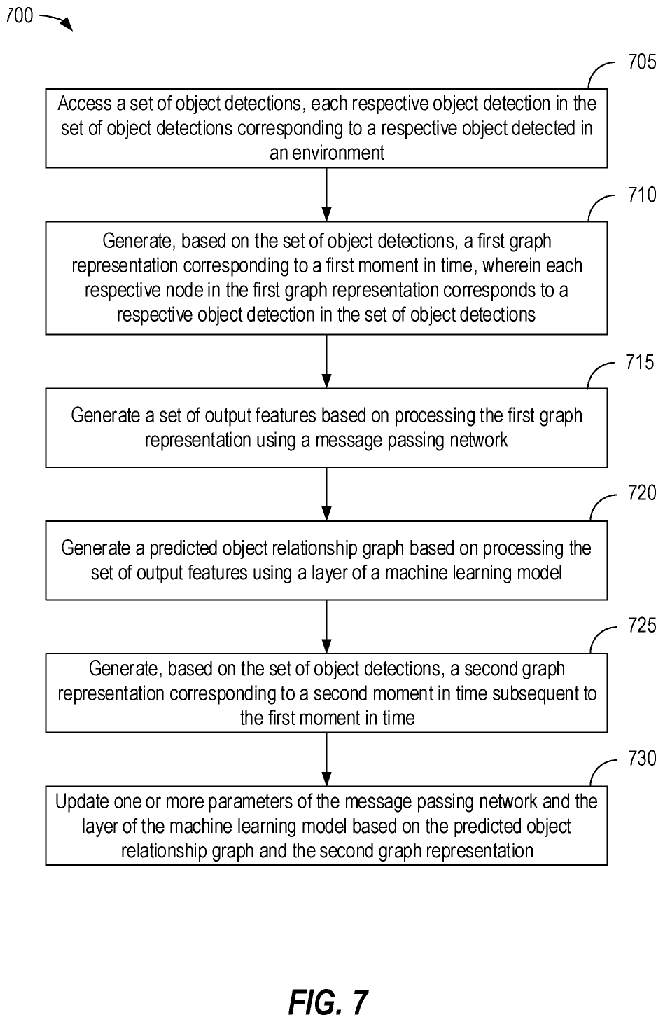

FIG. 7 is a flow diagram depicting an example method 700 for training machine learning models, according to various aspects of the present disclosure. In some aspects, the method 700 is performed by a training system (e.g., a computing system that trains graph neural networks for deployment), such as the training component 220 of FIG. 2.

At block 705, a set of object detections is accessed. Each respective object detection in the set of object detections corresponds to a respective object detected in an environment.

At block 710, a first graph representation corresponding to a first moment in time is generated based on the set of object detections. Each respective node in the first graph representation corresponds to a respective object detection in the set of object detections.

In some aspects, generating the first graph representation comprises generating, for each respective node in the first graph representation, a respective feature vector describing properties of a respective object in the environment.

In some aspects, the properties of the respective object comprise at least one of: (i) a position of the respective object, (ii) a size of the respective object, (iii) an orientation of the respective object, (iv) a texture of the respective object, (v) a vulnerability measure of the respective object, (vi) a visibility of the respective object, (vii) a velocity of the respective object, (viii) an acceleration of the respective object, (ix) contents of the respective object, or (x) a status of the respective object.

In some aspects, generating the first graph representation comprises, for at least a first pair of nodes in the first graph representation, the first pair of nodes corresponding to a first object and a second object in the environment, generating a first edge connecting the first pair of nodes, and generating a first feature vector describing one or more relationships between the first and second objects.

In some aspects, the one or more relationships between the first and second objects comprise at least one of: (i) relative distance between the first and second objects, (ii) relative velocity between the first and second objects, (iii) relative acceleration between the first and second objects, (iv) relative position between the first and second objects, (v) relative angle between the first and second objects, (vi) semantic similarity of the first and second objects, or (vii) geometric similarity of the first and second objects.

At block 715, a set of output features is generated based on processing the first graph representation using a message passing network.

In some aspects, generating the set of output features comprises, for a first node in the first graph representation, generating, for each respective edge connecting a respective neighbor node to the first node, a respective message vector based on a feature vector of the first node, a respective feature vector of the respective neighbor node, and a respective feature vector of the respective edge and generating a first output feature based on aggregating the respective message vectors for the first node using a graph convolutional layer of the machine learning model.

At block 720, a predicted object relationship graph is generated based on processing the set of output features using a layer of a machine learning model.

In some aspects, generating the predicted object relationship graph comprises, for at least a first pair of nodes in the first graph representation, the first pair of nodes corresponding to a first object and a second object in the environment, predicting an object relationship between the first and second objects based on processing output features of the first pair of nodes using the layer of the machine learning model.

In some aspects, generating the predicted object relationship graph comprises, for at least a second pair of nodes in the first graph representation, the second pair of nodes corresponding to a third object and a fourth object in the environment, pruning an edge connecting the second pair of nodes based on processing output features of the second pair of nodes using the layer of the machine learning model.

At block 725, a second graph representation corresponding to a second moment in time subsequent to the first moment in time is generated based on the set of object detections.

At block 730, one or more parameters of the message passing network and the layer of the machine learning model are updated based on the predicted object relationship graph and the second graph representation.

### Example Method for Predicting Object Relationships Using Machine Learning

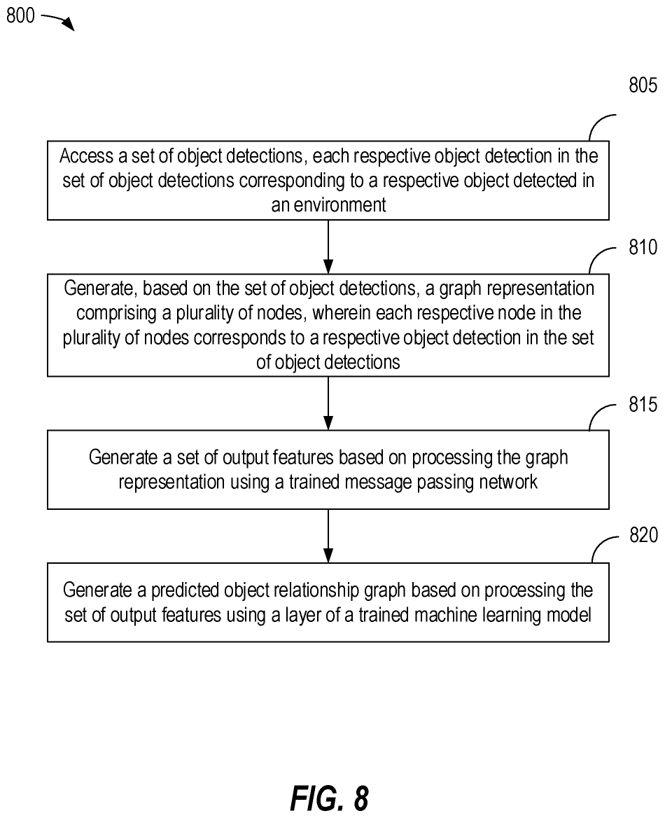

FIG. 8 is a flow diagram depicting an example method 800 for predicting object relationships using machine learning, according to various aspects of the present disclosure. In some aspects, the method 800 is performed by an inferencing system (e.g., a computing system that uses trained graph neural networks to generate predictions).

At block 805, a set of object detections is accessed. Each respective object detection in the set of object detections corresponds to a respective object detected in an environment.

At block 810, a graph representation comprising a plurality of nodes is generated based on the set of object detections. Each respective node in the plurality of nodes corresponds to a respective object detection in the set of object detections.

In some aspects, generating the graph representation comprises generating, for each respective node in the graph representation, a respective feature vector describing properties of a respective object in the environment.

In some aspects, the properties of the respective object comprise at least one of: (i) a position of the respective object, (ii) a size of the respective object, (iii) an orientation of the respective object, (iv) a texture of the respective object, (v) a vulnerability measure of the respective object. (vi) a visibility of the respective object, (vii) a velocity of the respective object. (viii) an acceleration of the respective object, (ix) contents of the respective object, or (x) a status of the respective object.

In some aspects, generating the first graph representation comprises, for at least a first pair of nodes in the first graph representation, the first pair of nodes corresponding to a first object and a second object in the environment, generating a first edge connecting the first pair of nodes, and generating a first feature vector describing one or more relationships between the first and second objects.

In some aspects, the one or more relationships between the first and second objects comprise at least one of: (i) relative distance between the first and second objects, (ii) relative velocity between the first and second objects, (iii) relative acceleration between the first and second objects, (iv) relative position between the first and second objects, (v) relative angle between the first and second objects, (vi) semantic similarity of the first and second objects, or (vii) geometric similarity of the first and second objects.

At block 815, a set of output features is generated based on processing the graph representation using a trained message passing network.

In some aspects, generating the set of output features comprises, for a first node in the graph representation, generating, for each respective edge connecting a respective neighbor node to the first node, a respective message vector based on a feature vector of the first node, a respective feature vector of the respective neighbor node, and a respective feature vector of the respective edge and generating a first output feature based on aggregating the respective message vectors for the first node using a graph convolutional layer of the trained machine learning model.

At block 820, a predicted object relationship graph is generated based on processing the set of output features using a layer of a trained machine learning model.

In some aspects, generating the predicted object relationship graph comprises, for at least a first pair of nodes in the graph representation, the first pair of nodes corresponding to a first object and a second object in the environment, predicting an object relationship between the first and second objects based on processing output features of the first pair of nodes using the layer of the trained machine learning model.

In some aspects, generating the predicted object relationship graph comprises, for at least a second pair of nodes in the graph representation, the second pair of nodes corresponding to a third object and a fourth object in the environment, pruning an edge connecting the second pair of nodes based on processing output features of the second pair of nodes using the layer of the trained machine learning model.

In some aspects, the method 800 further includes generating one or more actions to be performed by an autonomous vehicle based on the predicted object relationship graph. In some aspects, generating the one or more actions comprises generating a planned movement path for the autonomous vehicle.

### Example Processing System for Object Association

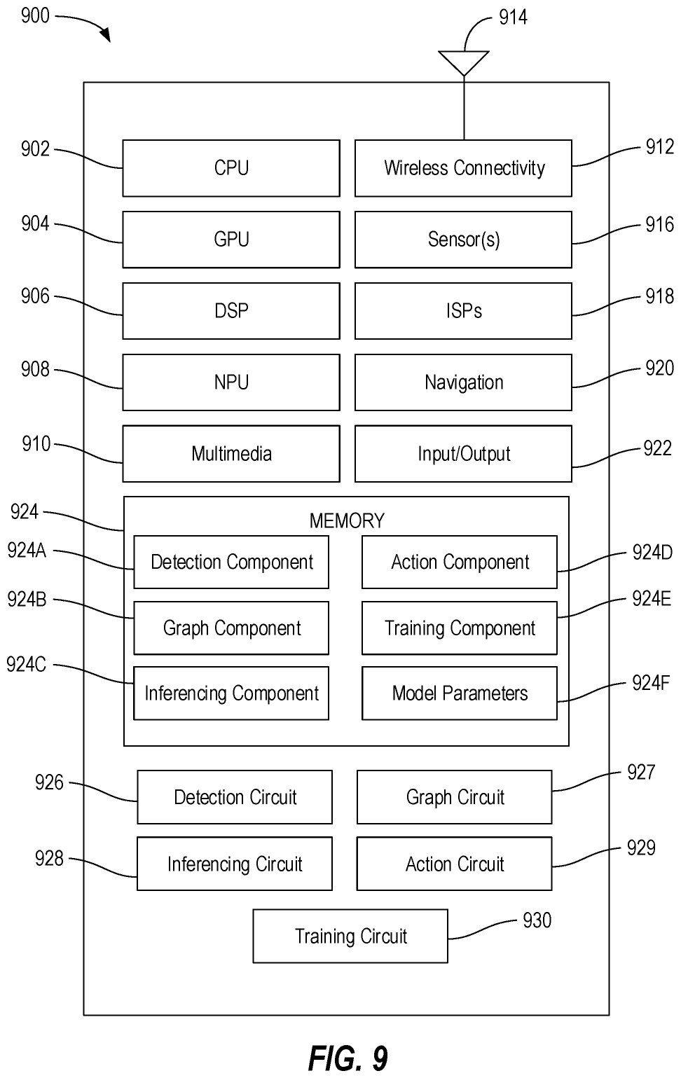

In some aspects, the workflows, techniques, and methods described with reference to FIGS. 1-8 may be implemented on one or more devices or systems. FIG. 9 depicts an example processing system 900 configured to perform various aspects of the present disclosure, including, for example, the techniques and methods described with respect to FIGS. 1-8. In some aspects, the processing system 900 may correspond to an inferencing system that uses trained machine learning models to predict object associations, and/or to a training system that trains machine learning models to predict object associations. Although depicted as a single system for conceptual clarity, in some aspects, as discussed above, the operations described below with respect to the processing system 900 may be distributed across any number of devices or systems.

The processing system 900 includes a central processing unit (CPU) 902, which in some examples may be a multi-core CPU. Instructions executed at the CPU 902 may be loaded, for example, from a program memory associated with the CPU 902 or may be loaded from a memory partition (e.g., a partition of memory 924).

The processing system 900 also includes additional processing components tailored to specific functions, such as a graphics processing unit (GPU) 904, a digital signal processor (DSP) 906, a neural processing unit (NPU) 908, a multimedia component 910 (e.g., a multimedia processing unit), and a wireless connectivity component 912.

An NPU, such as NPU 908, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 908, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 908 is a part of one or more of the CPU 902, the GPU 904, and/or the DSP 906.

In some examples, the wireless connectivity component 912 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 912 is further coupled to one or more antennas 914.

The processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS), as well as inertial positioning system components.

The processing system 900 may also include one or more input and/or output devices 922, such as screens, touch-sensitive surfaces (including touch-sensitive displays), physical buttons, speakers, microphones, and the like.

In some examples, one or more of the processors of the processing system 900 may be based on an ARM or RISC-V instruction set.

The processing system 900 also includes the memory 924, which is representative of one or more static and/or dynamic memories, such as a dynamic random access memory, a flash-based static memory, and the like. In this example, the memory 924 includes computer-executable components, which may be executed by one or more of the aforementioned processors of the processing system 900.

In particular, in this example, the memory 924 includes a detection component 924A, a graph component 924B, an inferencing component 924C, an action component 924D, and a training component 924E. The memory 924 further includes model parameters 924F for one or more models (e.g., parameters of the graph neural network 130 of FIG. 1). Although not included in the illustrated example, in some aspects the memory 924 may also include other data, such as training data (e.g., the environment data 105 of FIG. 1). Though depicted as discrete components for conceptual clarity in FIG. 9, the illustrated components (and others not depicted) may be collectively or individually implemented in various aspects.

The processing system 900 further comprises a detection circuit 926, a graph circuit 927, an inferencing circuit 928, an action circuit 929, and a training circuit 930. The depicted circuits, and others not depicted, may be configured to perform various aspects of the techniques described herein.

For example, the detection component 924A and/or the detection circuit 926 (which may correspond to the detection component 110 of FIG. 1) may be used to generate object detections (e.g., object detections 115 of FIG. 1) based on sensor data (e.g., the environment data 105 of FIG. 1), as discussed above. For example, the detection component 924A and/or the detection circuit 926 may use various techniques and operations to generate detections comprising bounding boxes and/or other attributes for each object detected in the sensor data.

The graph component 924B and/or the graph circuit 927 (which may correspond to the graph component 120 of FIG. 1) may be used to generate graph representations (e.g., the graph representation 125 of FIG. 1) of object detections, as discussed above. For example, the graph component 924B and/or the graph circuit 927 may generate graphs having a respective node for each respective object detection, and a set of edges connecting all pairs of nodes. In some aspects, the graph may also generate feature vectors for each node and/or edge based on the detections, as discussed above.

The inferencing component 924C and/or the inferencing circuit 928 (which may correspond to or use the graph neural network 130 of FIG. 1) may be used to generate predicted relationships (e.g., the predicted object relationship graph 135 of FIG. 1), as discussed above. For example, the inferencing component 924C and/or the inferencing circuit 928 may process the graph representation using a message passing network (e.g., message passing network 205 of FIG. 2) through one or more iterations to generate updated node feature vectors (e.g., features 210 of FIG. 2), and process these updated features using a final layer (e.g., fully connected layer 215 of FIG. 2) to generate the predicted object relationship graph.

The action component 924D and/or the action circuit 929 (which may correspond to the action component 140 of FIG. 1) may be used to generate or select actions to take (e.g., actions 145 of FIG. 1) based on the predicted object relationship graph(s), as discussed above. For example, the action component 924D and/or the action circuit 929 may generate planned movement paths or instructions, predicted object movements, and the like based on the graph.

The training component 924E and/or the training circuit 930 (which may correspond to the training component 220 of FIG. 2) may be used to train graph neural networks (e.g., the graph neural network 130 of FIG. 1), as discussed above. For example, the training component 924E and/or the training circuit 930 may compare predicted object relationship graphs (indicating predicted relationships at a future time, relative to the time of the detections used to generate the prediction) with actual graph representations (from the future time), and update the model parameters based on this comparison (e.g., using backpropagation).

Though depicted as separate components and circuits for clarity in FIG. 9, the detection circuit 926, the graph circuit 927, the inferencing circuit 928, the action circuit 929, and the training circuit 930 may collectively or individually be implemented in other processing devices of the processing system 900, such as within the CPU 902, the GPU 904, the DSP 906, the NPU 908, and the like.

Generally, the processing system 900 and/or components thereof may be configured to perform the methods described herein.

Notably, in other aspects, elements of the processing system 900 may be omitted, such as where the processing system 900 is a server computer or the like. For example, the multimedia component 910, the wireless connectivity component 912, the sensor processing units 916, the ISPs 918, and/or the navigation processor 920 may be omitted in other aspects. Further, aspects of the processing system 900 may be distributed between multiple devices.

### Example Clauses

Implementation examples are described in the following numbered clauses:

Clause 1: A method, comprising: accessing a set of object detections, each respective object detection in the set of object detections corresponding to a respective object detected in an environment; generating, based on the set of object detections, a graph representation comprising a plurality of nodes, wherein each respective node in the plurality of nodes corresponds to a respective object detection in the set of object detections; generating a set of output features based on processing the graph representation using a trained message passing network; and generating a predicted object relationship graph based on processing the set of output features using a layer of a trained machine learning model.

Clause 2: A method according to Clause 1, wherein generating the graph representation comprises generating, for each respective node in the graph representation, a respective feature vector describing properties of a respective object in the environment.

Clause 3: A method according to Clause 2, wherein the properties of the respective object comprise at least one of: (i) a position of the respective object, (ii) a size of the respective object, (iii) an orientation of the respective object, (iv) a texture of the respective object, (v) a vulnerability measure of the respective object, (vi) a visibility of the respective object, (vii) a velocity of the respective object, (viii) an acceleration of the respective object, (ix) contents of the respective object, or (x) a status of the respective object.

Clause 4: A method according to any of Clauses 1-3, wherein generating the first graph representation comprises, for at least a first pair of nodes in the first graph representation, the first pair of nodes corresponding to a first object and a second object in the environment, generating a first edge connecting the first pair of nodes, and generating a first feature vector describing one or more relationships between the first and second objects.

Clause 5: A method according to Clause 4, wherein the one or more relationships between the first and second objects comprise at least one of: (i) relative distance between the first and second objects, (ii) relative velocity between the first and second objects, (iii) relative acceleration between the first and second objects, (iv) relative position between the first and second objects, (v) relative angle between the first and second objects, (vi) semantic similarity of the first and second objects, or (vii) geometric similarity of the first and second objects.

Clause 6: A method according to any of Clauses 1-5, wherein generating the set of output features comprises, for a first node in the graph representation, generating, for each respective edge connecting a respective neighbor node to the first node, a respective message vector based on a feature vector of the first node, a respective feature vector of the respective neighbor node, and a respective feature vector of the respective edge and generating a first output feature based on aggregating the respective message vectors for the first node using a graph convolutional layer of the trained machine learning model.

Clause 7: A method according to any of Clauses 1-6, wherein generating the predicted object relationship graph comprises, for at least a first pair of nodes in the graph representation, the first pair of nodes corresponding to a first object and a second object in the environment, predicting an object relationship between the first and second objects based on processing output features of the first pair of nodes using the layer of the trained machine learning model.

Clause 8: A method according to Clause 7, wherein generating the predicted object relationship graph comprises, for at least a second pair of nodes in the graph representation, the second pair of nodes corresponding to a third object and a fourth object in the environment, pruning an edge connecting the second pair of nodes based on processing output features of the second pair of nodes using the layer of the trained machine learning model.

Clause 9: A method according to any of Clauses 1-8, further comprising generating one or more actions to be performed by an autonomous vehicle based on the predicted object relationship graph.

Clause 10: A method according to Clause 8, wherein generating the one or more actions comprises generating a planned movement path for the autonomous vehicle.

Clause 11: A method, comprising: accessing a set of object detections, each respective object detection in the set of object detections corresponding to a respective object detected in an environment; generating, based on the set of object detections, a first graph representation corresponding to a first moment in time, wherein each respective node in the first graph representation corresponds to a respective object detection in the set of object detections; generating a set of output features based on processing the first graph representation using a message passing network; generating a predicted object relationship graph based on processing the set of output features using a layer of a machine learning model; generating, based on the set of object detections, a second graph representation corresponding to a second moment in time subsequent to the first moment in time; and updating one or more parameters of the message passing network and the layer of the machine learning model based on the predicted object relationship graph and the second graph representation.

Clause 12: A method according to Clause 11, wherein generating the first graph representation comprises generating, for each respective node in the first graph representation, a respective feature vector describing properties of a respective object in the environment.

Clause 13: A method according to Clause 12, wherein the properties of the respective object comprise at least one of: (i) a position of the respective object, (ii) a size of the respective object, (iii) an orientation of the respective object. (iv) a texture of the respective object, (v) a vulnerability measure of the respective object, (vi) a visibility of the respective object, (vii) a velocity of the respective object, (viii) an acceleration of the respective object, (ix) contents of the respective object, or (x) a status of the respective object.

Clause 14: A method according to any of Clauses 11-13, wherein generating the first graph representation comprises, for at least a first pair of nodes in the first graph representation, the first pair of nodes corresponding to a first object and a second object in the environment, generating a first edge connecting the first pair of nodes, and generating a first feature vector describing one or more relationships between the first and second objects.

Clause 15: A method according to Clause 14, wherein the one or more relationships between the first and second objects comprise at least one of: (i) relative distance between the first and second objects, (ii) relative velocity between the first and second objects, (iii) relative acceleration between the first and second objects, (iv) relative position between the first and second objects, (v) relative angle between the first and second objects, (vi) semantic similarity of the first and second objects, or (vii) geometric similarity of the first and second objects.

Clause 16: A method according to any of Clauses 11-15, wherein generating the set of output features comprises, for a first node in the first graph representation, generating, for each respective edge connecting a respective neighbor node to the first node, a respective message vector based on a feature vector of the first node, a respective feature vector of the respective neighbor node, and a respective feature vector of the respective edge and generating a first output feature based on aggregating the respective message vectors for the first node using a graph convolutional layer of the machine learning model.

Clause 17: A method according to any of Clauses 11-16, wherein generating the predicted object relationship graph comprises, for at least a first pair of nodes in the first graph representation, the first pair of nodes corresponding to a first object and a second object in the environment, predicting an object relationship between the first and second objects based on processing output features of the first pair of nodes using the layer of the machine learning model.

Clause 18: A method according to Clause 17, wherein generating the predicted object relationship graph comprises, for at least a second pair of nodes in the first graph representation, the second pair of nodes corresponding to a third object and a fourth object in the environment, pruning an edge connecting the second pair of nodes based on processing output features of the second pair of nodes using the layer of the machine learning model.

Clause 19: A processing system comprising: a memory comprising computer-executable instructions; and one or more processors configured to execute the computer-executable instructions and cause the processing system to perform a method in accordance with any of Clauses 1-18.

Clause 20: A processing system comprising means for performing a method in accordance with any of Clauses 1-18.

Clause 21: A non-transitory computer-readable medium comprising computer-executable instructions that, when executed by one or more processors of a processing system, cause the processing system to perform a method in accordance with any of Clauses 1-18.

Clause 22: A non-transitory computer-readable medium encoding logic that, when executed by a processing system, causes the processing system to perform a method in accordance with any of Clauses 1-18.

Clause 23: An apparatus comprising logic circuitry configured to perform a method in accordance with any of Clauses 1-18.

Clause 24: A computer program product embodied on a computer-readable storage medium comprising code for performing a method in accordance with any of Clauses 1-18.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising processor-executable instructions; and
one or more processors configured to execute the processor-executable instructions and cause the processing system to:
access a set of object detections, each respective object detection in the set of object detections corresponding to a respective object detected in an environment;
generate, based on the set of object detections, a graph representation comprising a plurality of nodes, wherein each respective node in the plurality of nodes corresponds to a respective object detection in the set of object detections;
generate a set of output features, wherein, to generate the set of output features, the one or more processors are configured to execute the processor-executable instructions to cause the processing system to process the graph representation using a trained message passing network; and
generate a predicted object relationship graph, wherein, to generate the predicted object relationship graph, the one or more processors are configured to execute the processor-executable instructions to cause the processing system to process the set of output features using a layer of a trained machine learning model.

2. The processing system of claim 1, wherein, to generate the graph representation, the one or more processors are configured to execute the processor-executable instructions to cause the processing system to generate, for each respective node in the graph representation, a respective feature vector describing properties of a respective object in the environment.

3. The processing system of claim 2, wherein the properties of the respective object comprise at least one of:
(i) a position of the respective object,
(ii) a size of the respective object,
(iii) an orientation of the respective object,
(iv) a texture of the respective object,
(v) a vulnerability measure of the respective object,
(vi) a visibility of the respective object,
(vii) a velocity of the respective object,
(viii) an acceleration of the respective object,
(ix) contents of the respective object, or
(x) a status of the respective object.

4. The processing system of claim 1, wherein, to generate the graph representation, the one or more processors are configured to execute the processor-executable instructions to cause the processing system to, for at least a first pair of nodes in the graph representation, the first pair of nodes corresponding to a first object and a second object in the environment:
generate a first edge connecting the first pair of nodes; and
generate a first feature vector describing one or more relationships between the first and second objects.

5. The processing system of claim 4, wherein the one or more relationships between the first and second objects comprise at least one of:
(i) relative distance between the first and second objects,
(ii) relative velocity between the first and second objects,
(iii) relative acceleration between the first and second objects,
(iv) relative position between the first and second objects,
(v) relative angle between the first and second objects,
(vi) semantic similarity of the first and second objects, or
(vii) geometric similarity of the first and second objects.

6. The processing system of claim 1, wherein, to generate the set of output features, the one or more processors are configured to execute the processor-executable instructions to cause the processing system to, for a first node in the graph representation:
generate, for each respective edge connecting a respective neighbor node to the first node, a respective message vector based on a feature vector of the first node, a respective feature vector of the respective neighbor node, and a respective feature vector of the respective edge; and
generate a first output feature, wherein, to generate the first output feature, the one or more processors are configured to execute the processor-executable instructions to cause the processing system to aggregate the respective message vectors for the first node based on a graph convolutional layer of the trained machine learning model.

7. The processing system of claim 1, wherein:
to generate the predicted object relationship graph, the one or more processors are configured to execute the processor-executable instructions to cause the processing system to, for at least a first pair of nodes in the graph representation, the first pair of nodes corresponding to a first object and a second object in the environment, predict an object relationship between the first and second objects; and
to predict the object relationship between the first and second objects, the one or more processors are configured to execute the processor-executable instructions to cause the processing system to process output features of the first pair of nodes using the layer of the trained machine learning model.

8. The processing system of claim 7, wherein:
to generate the predicted object relationship graph, the one or more processors are configured to execute the processor-executable instructions to cause the processing system to, for at least a second pair of nodes in the graph representation, the second pair of nodes corresponding to a third object and a fourth object in the environment, prune an edge connecting the second pair of nodes; and
to prune the edge, the one or more processors are configured to execute the processor-executable instructions to cause the processing system to process output features of the second pair of nodes using the layer of the trained machine learning model.

9. The processing system of claim 1, wherein the one or more processors are configured to further execute the processor-executable instructions to cause the processing system to generate one or more actions to be performed by an autonomous vehicle based on the predicted object relationship graph.

10. The processing system of claim 9, wherein, to generate the one or more actions, the one or more processors are configured to execute the processor-executable instructions to cause the processing system to generate a planned movement path for the autonomous vehicle.

11. A processing system comprising:
one or more memories comprising processor-executable instructions; and
one or more processors configured to execute the processor-executable instructions and cause the processing system to:
access a set of object detections, each respective object detection in the set of object detections corresponding to a respective object detected in an environment;
generate, based on the set of object detections, a first graph representation corresponding to a first moment in time, wherein each respective node in the first graph representation corresponds to a respective object detection in the set of object detections;
generate a set of output features based on processing the first graph representation using a message passing network;
generate a predicted object relationship graph based on processing the set of output features using a layer of a machine learning model;
generate, based on the set of object detections, a second graph representation corresponding to a second moment in time subsequent to the first moment in time; and
update one or more parameters of the message passing network and the layer of the machine learning model based on the predicted object relationship graph and the second graph representation.

12. The processing system of claim 11, wherein, to generate the first graph representation, the one or more processors are configured to execute the processor-executable instructions to cause the processing system to generate, for each respective node in the first graph representation, a respective feature vector describing properties of a respective object in the environment.

13. The processing system of claim 12, wherein the properties of the respective object comprise at least one of:
(i) a position of the respective object,
(ii) a size of the respective object,
(iii) an orientation of the respective object,
(iv) a texture of the respective object,
(v) a vulnerability measure of the respective object,
(vi) a visibility of the respective object,
(vii) a velocity of the respective object,
(viii) an acceleration of the respective object,
(ix) contents of the respective object, or
(x) a status of the respective object.

14. The processing system of claim 11, wherein, to generate the first graph representation, the one or more processors are configured to execute the processor-executable instructions to cause the processing system to, for at least a first pair of nodes in the first graph representation, the first pair of nodes corresponding to a first object and a second object in the environment:
generate a first edge connecting the first pair of nodes; and
generate a first feature vector describing one or more relationships between the first and second objects.

15. The processing system of claim 14, wherein the one or more relationships between the first and second objects comprise at least one of:
(i) relative distance between the first and second objects,
(ii) relative velocity between the first and second objects,
(iii) relative acceleration between the first and second objects,
(iv) relative position between the first and second objects,
(v) relative angle between the first and second objects,
(vi) semantic similarity of the first and second objects, or
(vii) geometric similarity of the first and second objects.

16. The processing system of claim 11, wherein, to generate the set of output features, the one or more processors are configured to execute the processor-executable instructions to cause the processing system to, for a first node in the first graph representation:
generate, for each respective edge connecting a respective neighbor node to the first node, a respective message vector based on a feature vector of the first node, a respective feature vector of the respective neighbor node, and a respective feature vector of the respective edge; and
generate a first output feature, wherein, to generate the first output feature, the one or more processors are configured to execute the processor-executable instructions to cause the processing system to aggregate the respective message vectors for the first node using a graph convolutional layer of the machine learning model.

17. The processing system of claim 11, wherein:
to generate the predicted object relationship graph, the one or more processors are configured to execute the processor-executable instructions to cause the processing system to, for at least a first pair of nodes in the first graph representation, the first pair of nodes corresponding to a first object and a second object in the environment, predict an object relationship between the first and second objects; and
to predict the object relationship, the one or more processors are configured to execute the processor-executable instructions to cause the processing system to process output features of the first pair of nodes using the layer of the machine learning model.

18. The processing system of claim 17, wherein:
to generate the predicted object relationship graph, the one or more processors are configured to execute the processor-executable instructions to cause the processing system to, for at least a second pair of nodes in the first graph representation, the second pair of nodes corresponding to a third object and a fourth object in the environment, prune an edge connecting the second pair of nodes; and
to prune the edge, the one or more processors are configured to execute the processor-executable instructions to cause the processing system to process output features of the second pair of nodes using the layer of the machine learning model.

19. A processor-implemented method, comprising:
accessing a set of object detections, each respective object detection in the set of object detections corresponding to a respective object detected in an environment;
generating, based on the set of object detections, a graph representation comprising a plurality of nodes, wherein each respective node in the plurality of nodes corresponds to a respective object detection in the set of object detections;
generating a set of output features based on processing the graph representation using a trained message passing network; and
generating a predicted object relationship graph based on processing the set of output features using a layer of a trained machine learning model.

20. The processor-implemented method of claim 19, wherein generating the graph representation comprises generating, for each respective node in the graph representation, a respective feature vector describing properties of a respective object in the environment.

21. The processor-implemented method of claim 20, wherein the properties of the respective object comprise at least one of:
(i) a position of the respective object,
(ii) a size of the respective object,
(iii) an orientation of the respective object,
(iv) a texture of the respective object,
(v) a vulnerability measure of the respective object,
(vi) a visibility of the respective object,
(vii) a velocity of the respective object,
(viii) an acceleration of the respective object,
(ix) contents of the respective object, or
(x) a status of the respective object.

22. The processor-implemented method of claim 19, wherein generating the graph representation comprises, for at least a first pair of nodes in the graph representation, the first pair of nodes corresponding to a first object and a second object in the environment:
generating a first edge connecting the first pair of nodes; and
generating a first feature vector describing one or more relationships between the first and second objects.

23. The processor-implemented method of claim 22, wherein the one or more relationships between the first and second objects comprise at least one of:
(i) relative distance between the first and second objects,
(ii) relative velocity between the first and second objects,
(iii) relative acceleration between the first and second objects,
(iv) relative position between the first and second objects,
(v) relative angle between the first and second objects,
(vi) semantic similarity of the first and second objects, or
(vii) geometric similarity of the first and second objects.

24. The processor-implemented method of claim 19, wherein generating the set of output features comprises, for a first node in the graph representation:
generating, for each respective edge connecting a respective neighbor node to the first node, a respective message vector based on a feature vector of the first node, a respective feature vector of the respective neighbor node, and a respective feature vector of the respective edge; and
generating a first output feature based on aggregating the respective message vectors for the first node using a graph convolutional layer of the trained machine learning model.

25. The processor-implemented method of claim 19, wherein generating the predicted object relationship graph comprises, for at least a first pair of nodes in the graph representation, the first pair of nodes corresponding to a first object and a second object in the environment, predicting an object relationship between the first and second objects based on processing output features of the first pair of nodes using the layer of the trained machine learning model.

26. The processor-implemented method of claim 25, wherein generating the predicted object relationship graph comprises, for at least a second pair of nodes in the graph representation, the second pair of nodes corresponding to a third object and a fourth object in the environment, pruning an edge connecting the second pair of nodes based on processing output features of the second pair of nodes using the layer of the trained machine learning model.

27. The processor-implemented method of claim 19, further comprising generating one or more actions to be performed by an autonomous vehicle based on the predicted object relationship graph.

28. The processor-implemented method of claim 27, wherein generating the one or more actions comprises generating a planned movement path for the autonomous vehicle.

29. A processor-implemented method, comprising:
accessing a set of object detections, each respective object detection in the set of object detections corresponding to a respective object detected in an environment;
generating, based on the set of object detections, a first graph representation corresponding to a first moment in time, wherein each respective node in the first graph representation corresponds to a respective object detection in the set of object detections;
generating a set of output features based on processing the first graph representation using a message passing network;
generating a predicted object relationship graph based on processing the set of output features using a layer of a machine learning model;
generating, based on the set of object detections, a second graph representation corresponding to a second moment in time subsequent to the first moment in time; and
updating one or more parameters of the message passing network and the layer of the machine learning model based on the predicted object relationship graph and the second graph representation.

30. The processor-implemented method of claim 29, wherein:
generating the set of output features comprises, for a first node in the first graph representation:
generating, for each respective edge connecting a respective neighbor node to the first node, a respective message vector based on a feature vector of the first node, a respective feature vector of the respective neighbor node, and a respective feature vector of the respective edge; and
generating a first output feature based on aggregating the respective message vectors for the first node using a graph convolutional layer of the machine learning model; and
generating the predicted object relationship graph comprises, for at least a pair of nodes in the first graph representation, the pair of nodes corresponding to a first object and a second object in the environment, predicting an object relationship between the first and second objects based on processing output features of the pair of nodes using the layer of the machine learning model.
